(19) United States
(12) Patent Application Publication
(10) Pub. No.: US 2011/0047058 A1
(43) Pub. Date: Feb. 24, 2011

(54) APPARATUS AND METHOD FOR MODELING LOAN ATTRIBUTES

(75) Inventors: William C. Erbey, Atlanta, GA (US); Ashish Pandey, Bangalore (IN); Amanjeet Saluja, Bangalore (IN); Ankush Gupta, Bangalore (IN); Deepak Dhayanithy, Bangalore (IN); Raman Guglani, Bangalore (IN); Saket Giri, Bangalore (IN); Sulabh Dhall, Bangalore (IN)

Correspondence Address: ARENT FOX LLP, 1050 CONNECTICUT AVENUE, N.W., SUITE 400, WASHINGTON, DC, 20036, US

(73) Assignee: ALTISOURCE SOLUTIONS S.A.R.L., Luxembourg (LU)

(21) Appl. No.: 12/731,912

(22) Filed: Mar. 25, 2010

Related U.S. Application Data
(60) Provisional application No. 61/163,228, filed on Mar. 25, 2009.

(51) Int. Cl. G06Q 40/00

(52) U.S. Cl. 705/35

(57) ABSTRACT

A method, system, and computer program product for generating a model for predicting loan behavior, including receiving loan data for a plurality of loans; preparing the loan data for analysis; grouping the loans into a plurality of hierarchical segments based on shared characteristics; generating a logistic regression model for each segment; and generating an overall prediction model for at least one of prepayment, delinquency, and default across the plurality of segments. Grouping the loans into a plurality of segments based on shared characteristics may include grouping the loans based on loan type, change in Housing Price Index (HPI) since origination, and loan age. Generating a logistic regression model for each segment may include generating a regression model for the probabilities of each of prepayment, default, and delinquency for each of the segments.

### CLAIM OF PRIORITY UNDER 35 U.S.C. §119

The present application for patent claims priority to Provisional Application No. 61/163,228 entitled “APPARATUS AND METHOD FOR MODELING LOAN ATTRIBUTES” filed Mar. 25, 2009, the entire contents of which are incorporated by reference herein.

### BACKGROUND OF THE INVENTION

1. Field of the Invention

This application relates generally to modeling behaviors associated with loans, and more specifically to projecting prepayment, delinquency, and default probabilities associated with mortgage loans across loan ages.

2. Related Art

Prepayment, delinquency, and default projections are important elements in the valuation of servicing portfolios as well as in new deal pricing assessment. Curves or models representing these values have typically been built using curve-fitting exercises based on past data. While such an approach is useful in some instances, these curves are generally unreliable if there are significant market disruptions or if the curves change dramatically.

With the recent turmoil in the financial markets, changes in borrower behavior have resulted in significant changes to these curves. Continual fine-tuning and adjustments may now be required to accommodate these changes when performing curve fitting. As such, there is less confidence in future predictions through curve fitting because the fine tuning process is manual and relatively unstructured.

It would be desirable to have a statistically sound prediction approach deploying a suite of advanced statistical approaches, which can accommodate market shocks without requiring significant, continual fine-tuning.

### SUMMARY

Aspects in accordance with the present invention meet these needs by providing a statistically sound prediction approach for predicting loan attributes using regression techniques that can accommodate market shocks and that does not require significant, continual manual fine-tuning. A plurality of models are generated and used to predict the probability of loan behaviors, such as default, delinquency, and pre-payment.

Aspects include a method of generating a model for predicting loan behavior, the method including receiving loan data for a plurality of loans; preparing the loan data for analysis; grouping the loans into a plurality of hierarchical segments based on shared characteristics; generating a logistic regression model for each segment; and generating an overall prediction model for at least one of prepayment, delinquency, and default across the plurality of segments.

Preparing the loan data for analysis may include formatting, imputing missing data, and/or applying an outlier treatment to the loan data. Imputing missing data may include resetting interest rates applicable to ARM products. Applying an outlier treatment may include limiting the values of a particular field to a certain range. Grouping the loans into a plurality of segments based on shared characteristics may include grouping the loans based on loan type, change in Housing Price Index (HPI) since origination, and/or loan age. Generating a logistic regression model for each segment may include generating a regression model for the probabilities of prepayment, default, and/or delinquency for each of the segments.

Aspects may further include generating a calendar month wise model by applying the corresponding model to generate probabilities for each segment for the calendar month and combining the generated probabilities.

Aspects may further include scoring each loan at each age for probability or prepayment, default, and delinquency based on the corresponding generated models and the relevant data for each loan.

Aspects may further include calculating the current amount outstanding at the end of each month based on the generated probability models, calculating a probability of prepayment from the prepayment model, and/or calculating a projected unpaid principle balance at each age of the loan by multiplying the probability of prepayment by the current unpaid balance.

Aspects may further include a system for generating a model for predicting loan behavior, the system including means for receiving loan data for a plurality of loans; means for preparing the loan data for analysis; means for grouping the loans into a plurality of hierarchical segments based on shared characteristics; means for generating a logistic regression model for each segment; and means for generating an overall prediction model for at least one of prepayment, delinquency, and default across the plurality of segments.

Aspects may further include a system for generating a model for predicting loan behavior, the system including a processor; a user interface functioning via the processor; and a repository accessible by the processor; wherein the repository is configured to receive and store loan data for a plurality of loans, and wherein the processor is configured to: prepare the loan data for analysis; group the loans into a plurality of hierarchical segments based on shared characteristics; generate a logistic regression model for each segment; and generate an overall prediction model for at least one of prepayment, delinquency, and default across the plurality of segments.

Additional advantages and novel features of these aspects of the invention will be set forth in part in the description that follows, and in part will become more apparent to those skilled in the art upon examination of the following or upon learning by practice of the invention.

### DESCRIPTION OF THE DRAWINGS

Various exemplary embodiments of the systems and methods will be described in detail, with reference to the following figures, wherein:

FIG. 1 depicts a system for predicting loan behaviors, in accordance with aspects of the present invention.

FIG. 2 is a block diagram depicting the subdivision of loan data, in accordance with aspects of the present invention.

FIG. 3 depicts a process for predicting loan behaviors, in accordance with aspects of the present invention.

FIG. 4 depicts a process for grouping a plurality of loans in order to generate models.

FIG. 5 depicts a computer system for implementing various aspects of the present invention.

FIG. 6 is a block diagram of various exemplary system components, in accordance with aspects of the present invention.

### DETAILED DESCRIPTION

These and other features and advantages of this invention are described in, or are apparent from, the following detailed description of various exemplary embodiments.

A statistically sound prediction approach for predicting loan attributes is described herein using regression techniques that can accommodate market shocks and does not require significant, continual manual fine-tuning. A plurality of models are generated and used to predict the probability of loan behaviors, such as default, delinquency, and pre-payment.

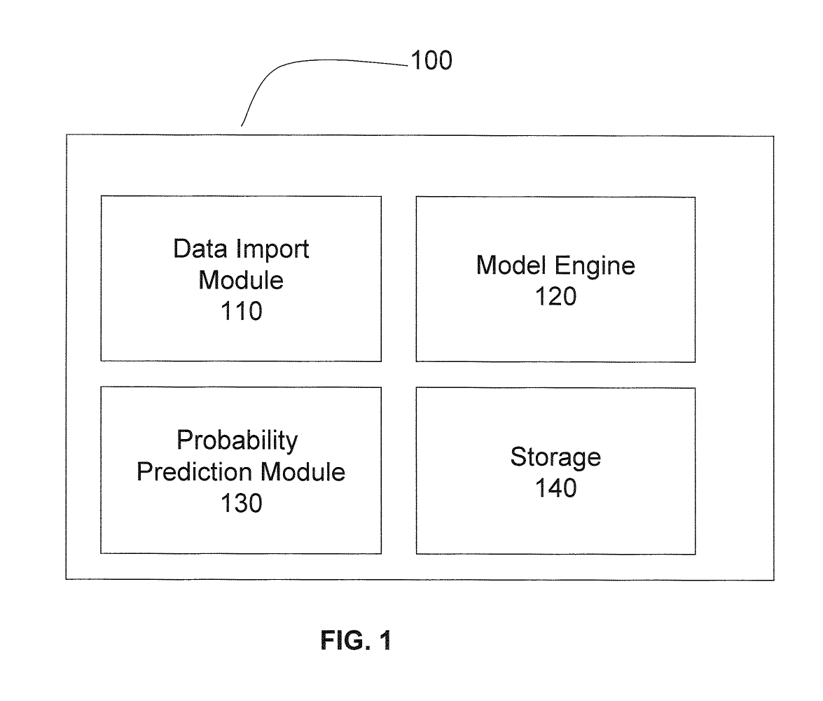

FIG. 1 depicts a block diagram of a system 100 for predicting various loan behaviors, in accordance with some exemplary aspects. System 100 may include a data import module 110, model engine 120, a probability prediction module 130, and one or more storage components 140. Data import module 110 may be configured to gather loan data from one or more sources, and to prepare the data for processing by the model engine 120 and probability prediction module 130. For example, data import module 110 may be configured to collect historical loan data used to generate a plurality of loan models. Data import model 110 may also be configured to import data from a deal tape, the data representing loan products to which the models may be applied.

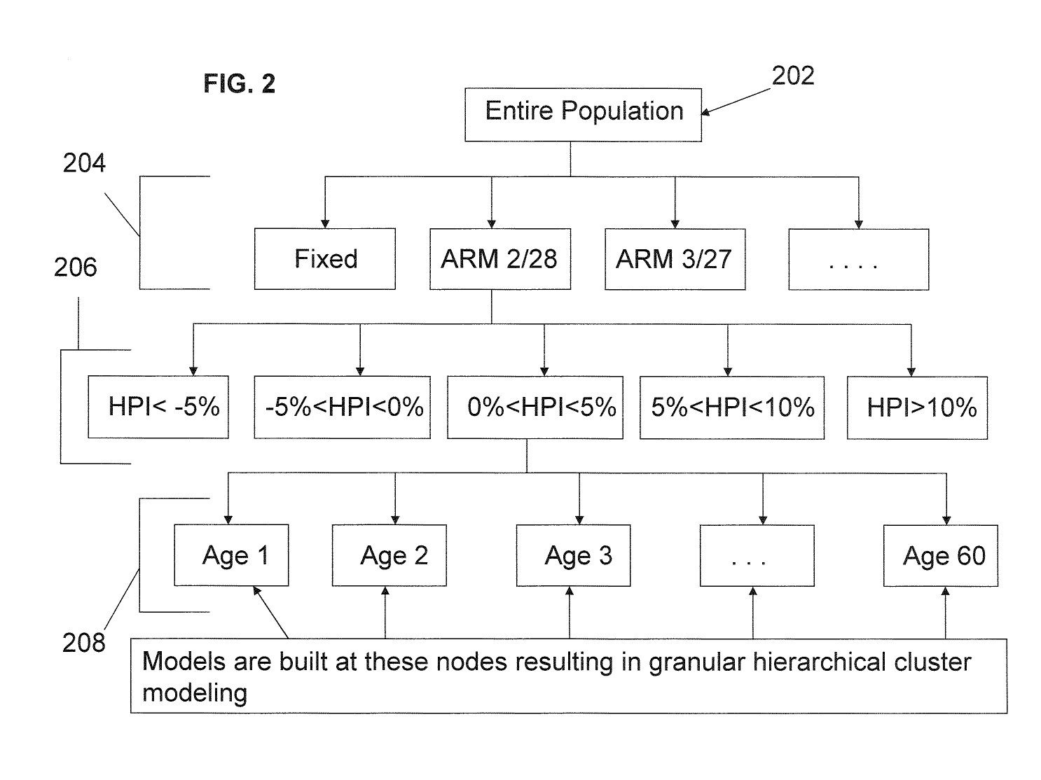

Modeling engine 120 may be configured to perform statistical processing on a predefined population of data to generate models which may be used to predict customer behaviors associated with various loan products. According to some aspects, the predefined data population includes historical loan data. The data may be split through a hierarchical clustering schema into a number of predetermined categories. FIG. 2 depicts an example of clustering/segmenting loan data, in accordance with various aspects of the invention. As depicted in FIG. 2, the entire population 202 of loan data may be first divided into categories based on the type of loan, as depicted at 204. For example, the population may divided into fixed loans, Adjustable Rate Mortgage (ARM) 2/28 loans, and ARM 3/27 loans. Other categories on loan types may be used additionally or alternatively.

As depicted at 206, for each loan type category, loans are further divided based on the housing price index (HPI) change associated with the loan since origination. For example, loans may be grouped as having an HPI change of less than −5% since origination, having an HPI change between 0% and 5% since origination, and having an HPI change greater than 10% since origination. Other groupings may also be used. HPI predications may be performed using econometric and time series ARIMA models, according to some aspects of the invention. HPI values, and thus the change from origination, may be available for any loan at any point in time.

Once the population has been segmented by product type and HPI change, the segments may be further split according to age of the loan, as depicted at 208. In according to some aspects, the loans may be segmented at each individual age level (e.g., 1 month, 2 months, etc.). In other aspects, loans may be grouped into age ranges, such as 1-5 months, 6-10 months, and/or any other age range grouping. For example, the loans may be separated into one month segments across 60 months. HPI change since origination and load age are values which change over time. As such, the segments may be considered dynamic segments. As the loans age, they move from one segment to another over time, and therefore have a different regression equation applied to them at different times.

Referring back to FIG. 1, for each generated segment, model engine 120 may be configured to build one or more logistic regression models. These logistic regression models may include, for example, prepayment models, delinquency models, and default models. An appropriate model may applied to each loan segmented through the dynamic clustering hierarchy depending on which segment the loan belongs to. Thus, each segment may include a regression model for prepayment, delinquency, and default. Table 1 illustrates an exemplary breakdown of numbers of models according to product type.

TABLE 1
Number of Models Across Products and Behavior

| Product | CPR | Default | Delinquency | Total |
|---|---|---|---|---|
| ARM 2/28 | 185 | | 237 | 422 |
| ARM 3/27 | 148 | | 147 | 295 |
| Fixed | 195 | | 200 | 395 |
| No Product | | 52 | | 52 |
| Split | | | | |
| Junior Lien | 184 | 36 | 184 | 404 |
| Total | 712 | 88 | 768 | 1568 |

To predict age level probabilities, all loans belonging to a particular age or age group are scored using appropriate models. The selection of models may depend on the product type and the HPI change observed since origination. The projected unpaid balance at each age is calculated by deducting the probability of default and probability of prepayment from the previous unpaid balance iteratively. These probabilities may be multiplied by their projected unpaid balance to get an expected voluntary payoff balance for that particular age. The voluntary payoff balance may be added across all loans of a particular age to get the total expected voluntary payoff balance. This value may then be divided by the total projected unpaid balance of loans of that age to determine a percentage of prepayment at that age. This value is known as the Single Month Mortality Rate (SMMR). The SMMR may then be converted to an annual Constant Default Rate (CPR) for the particular age, and the same process may then be repeated for all ages.

Model engine 120 may be further configured to calculate the probability of certain behaviors, using the generated models. Model engine 120 may be configured to generate probabilities of one or more behaviors for each age or age range for which models have been generated. For example, model engine 120 may be configured to calculate the probability of delinquency, prepayment, and default for each month of a loan's life.

The above-mentioned probabilities may be calculated using the following equation:

$$p = \frac{{e}^{α + {β}_{1} {X}_{1} + {β}_{2} {X}_{2} + … {β}_{k} {X}_{k}}}{1 + {e}^{α + {β}_{1} {X}_{1} + {β}_{2} {X}_{2} + … {β}_{k} {X}_{k}}} ,$$

where α represents a regression model constant, β represents coefficient of prediction for predictor X, and X represents any variable used in generating the model. Probability prediction module 140 may be configured to generate models plotting the probabilities. Table 2 illustrates exemplary variables, any combination of which may be used in generating a model for each segment. These variables may relate, for example, to the borrower, the property, the loan, or the product. Different combinations of variables may be employed with different coefficients for each of the models. Regression model constant α and coefficient predictors β₁, β₂, β₃ may be selected to match the equation to a measured curve.

TABLE 2
Possible Variables for Regression Models

| | | |
|---|---|---|
| Product Type | Floor for interest rate | MSA |
| | increase in a period | |
| First Reset time period for | Ceiling for interest rate | Case Shiller HPI |
| ARM (Blank for fixed) | increase in a period | |
| Lien type | Cap on first increment of | LIBOR 3 month |
| | interest rate | |
| Principle Balance at | Interest only flag (“Y” for | LIBOR 6 month |
| Origination | yes, “N” for no) | |
| Interest Rate at Origination | Margin of ARM interest rate | Foreclosure timeline |
| Term for which prepayment | CLTV at origination | Marketing timeline |
| penalty is applicable | | |
| Prepayment penalty rate | FICO at origination | MTA (Moving Treasury |
| | | Average) Rate |
| Period for interest only | Market value of property at | Prime Rate |
| payments | origination | |
| Interest rate cap (maximum) | Property occupancy status | T-Bill 3 month |
| for entire life of loan | (owner, investor, non | |
| | owner, other) | |
| Interest rate cap (minimum) | Property type (2f-two | |
| for entire life of loan | family, MH-multi-housing, | |
| | SF-single family, CO- | |
| | condo, etc. | |
| Frequency of rate change in | State in which property is | |
| months | located | |

All the variables listed in Table 1 are variables as of loan origination. The models may be built with only such variables, because in order to make future projections the unknown future values of these variables would be required. Therefore, the information available as of loan origination may be used as predictors in the generated models. For second lien models, the same variables may be used, however, the variables for both the second lien and its corresponding first lien will be required. The corresponding first lien may be scored as the second lien probabilities dependent on the behavior of its first lien.

Storage 140 may be provided to permanently and/or temporarily store data used in generating models and/or calculating probabilities for particular loans. For example, storage 140 may be configured to store historical loan data, data received from a deal tape, calculated probabilities, and/or other data.

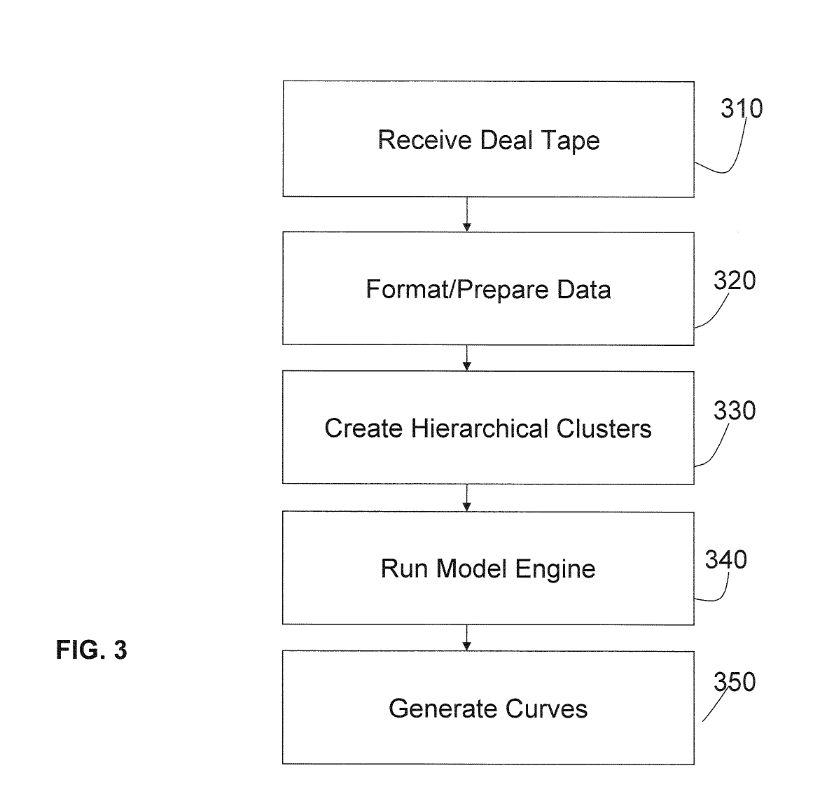

FIG. 3 is a flowchart depicting a process for predicting loan behavior, in accordance with some aspects. As depicted at 310, the process may begin when a deal tape is received. The deal tape may include a database providing details on multiple loans. The loans may make up a deal or portfolio. For example, the deal tape may outline the terms associated with a loan, as well as the loans current statistics, such as its origination date, loan type, property details, etc.

Upon receipt of the deal tape, data necessary for predicting a desired attribute may be formatted and prepared for modeling, as depicted at 320. Formatting may include, for example, replacing values of certain fields with standard values, which may be used in performing the prediction calculations. Formatting the data may also include imputing any missing data, creating any derived fields, and treating any outlier data.

When imputing missing data, the missing value may be replace with its most logical and probable value. For example, a field resetting interest rates may only be applicable to ARM products since a fixed product has a fixed rate across the lifetime of the product. Thus, if this field is blank or missing for a fixed product, a predefined status indicator may be inserted into the field.

Creating derived fields may include numerical/logical transformations of existing fields. For example, an HPI Change field may be derived for each loan based on the value at origination and current or projection values.

Outlier treatment may include limiting the values in a particular field to a certain range. Extreme values may cause the data to be unduly biased. For example, an original balance of greater than $2,000,000 may only apply to less than 0.5% of all loans. However, if such values were included in a calculation, a large biasing effect could result. As such, in accordance with some aspects of the invention, this balance may be limited to a value of $2,000,000.

Some variables used in performing calculations are derived from other fields. For example, one variable used in some models is the “Change over time in Housing Price Index.” This variable may be derived from the housing price index as of loan origination and the housing price index as of the current date. Other variables may also be derived from other fields.

After data has been formatted, hierarchical clusters may be created, as depicted at 330. More particularly, the loans may be divided into predetermined categories, such as those depicted in FIG. 2. Categories may include, for example, loan type, HPI change since origination, and loan age.

Among others, the loans may be segmented across first lien fixed, first lien ARM 2/28, first lien ARM 3/27, and junior lien products.

For example, HPI change may be evaluated across loans from their origination and the groups of loans may be further categorized based on HPI change. FIG. 2 illustrates exemplary categories for (a) HPI Change<−5%, (b) −5%<HPI Change<0%, (c) 0%<HPI Change<5%, (d) 5%<HPI Change<10%, and (e) HPI Change>10%. Although five HPI Change categories are illustrated, any number of HPI change categories may be applied. For example, in some loan products, all 5 HPI scenarios might not be able to be created because of a lack of data. In such situations, fewer HPI Change scenarios may be modeled by combining larger ranges into a single segment. For example, an ARM 3/27 may include four splits instead of the five illustrated in FIG. 2. In this example, the negative HPI Change segments may be combined into one segment, HPI<0%.

As the loans are segmented across age groups, models may be built at each individual age level segment. However, when the necessary amount of data is unavailable across all age groups, for each of the product and HPI Change segments, groups of ages may be combined above a certain point.

As depicted at 340, probabilities of voluntary prepayment, default, and delinquency may be determined for each age/age range, by running a model engine.

For the default model, a separate classification may be used. For example, adequate data might not be present to build a model specific to the different products. Therefore, a common set of models may be built for the default model. In addition, a different range of HPI Change may be applied to generate the default models. For example, the ranges may include (a) HPI Change<−10%, (b) −10%<HPI Change<−5%, (c) −5%<HPI Change<5%, and (d) HPI Change>5%. Additionally, for generating the default models, after the loans have been segmented based on HPI Change and age, the loans may be further segmented based on the probability of delinquency of the loan at that time.

For junior liens, the corresponding CPR/delinquency and default generated for the first liens may be applied as predictors into the models for the junior lien loan predictions.

According to some aspects, the current amount outstanding at the end of each month may be calculated based on the determined probability scores. The unpaid principal balance (UPB) at each age of the loan may be calculated, taking into consideration the probabilities of prepayment, default, and delinquency. These probabilities may be considered in combination, according to some aspects, or may be considered separately in other aspects of the invention.

Once the models are generated for each of the loan segments, each loan may be scored at each age for probability of voluntary prepayment, default, and delinquency. This scoring is done using the generated models for the appropriate segments and relevant loan data for each loan. A current amount outstanding at the end of each month may be calculated using probability of prepayment and default. Then, the aggregate scores of all the loans can be used to generate final CPR/CDR/Delinquency models

For example, the projected UPB at each age of a loan may be calculated by deducting the probability of prepayment from the previous UPB. More particularly, once the probability of prepayment has been calculated (as described above), the probability may be multiplied by the current unpaid balance. This value is then subtracted from the current unpaid balance to arrive at a projected UPB which accounts for prepayment. These calculations may be performed iteratively for each loan age.

An expected voluntary payoff balance for the particular age in question may be calculated by multiplying the projected UPB by the probability of prepayment. This process is repeated for all loans of a particular age. Next, the voluntary payoff values for each loan at the particular age may be combined to calculate the total expected voluntary payoff balance.

The total expected voluntary payoff balance may be divided by the total projected UPB of loans of that age to determine the percentage of prepayment. This value is known as the Single Month Mortality Rate (SMMR). The SMMR may be converted to an annual CPR for that age. This process may be repeated for all ages or defined age ranges.

For each calculated probability, the scores of all loans of a particular age may be aggregated and used to generate probability models, as depicted at 350. For example, to generate a Constant Prepayment Rate (CPR) model, the UPB calculated for each loan based on the probability of voluntary prepayment across a particular age is aggregated to get a total expected voluntary payoff balance. Similar calculations may be performed to generate Constant Default Rate (CDR) and delinquency models.

The generated models may be extracted, for example, into an XL file, and provided to Capital Markets or Business User teams

An exemplary implementation in accordance with aspects of the present invention will now be described for a CPR model for an ARM 2/28 product having HPI Change since origination of <−5% for an age of 26 months.

Table 3 lists variables and their corresponding β value estimate that may be used to generate this probability model for this segment.

| Variable | Loan Information | Estimate values |
|---|---|---|
| Intercept | | −10.6233, α |
| House price appreciation from | 15%, X₁ | 7.9855, β₁ |
| origination to twelve months | | |
| before current date | | |
| Interest rate applicable | 12%, X₂ | 0.2142, β₂ |
| Delinquency probability 3 | 2%, X₃ | −4.6028, β₃ |
| months earlier | | |
| Indicator for loan original | 1 ($50,000), X₄ | 0.5763, β₄ |
| principle balance between | | |
| 12,000 and 170,000 (takes | | |
| value 1, if loan original | | |
| principle balance lied within | | |
| this range) | | |
| Original combined loan to | 40, X₅ | 0.0244, β₅ |
| value (CLTV) | | |

Thus, for this loan, using this model, the score=α+X₁ β₁+X₂ β₂+X₃ β₃+X₄ β₄+X₅ β₅=−10.6233+7.9855*(0.15)+0.2142*0.02+0.5763*1−0.0244*40=−7.939527. The probability of repayment, p,=e^{score}/(1+e^{score})=0.04%. Thus, in this example, there is a very low chance that this loan will prepay at this time.

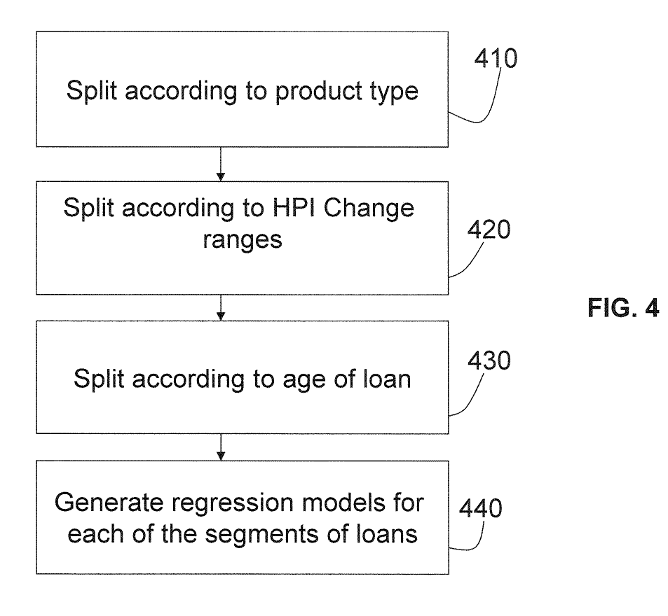

FIG. 4 illustrates an exemplary process for segmenting a plurality of loans into subgroups. At 410, the loans are split according to product type. At 420, the loans are split according to HPI Change ranges, at 430, the loans are split according to loan age, and at 440, models are generated for each of the segments.

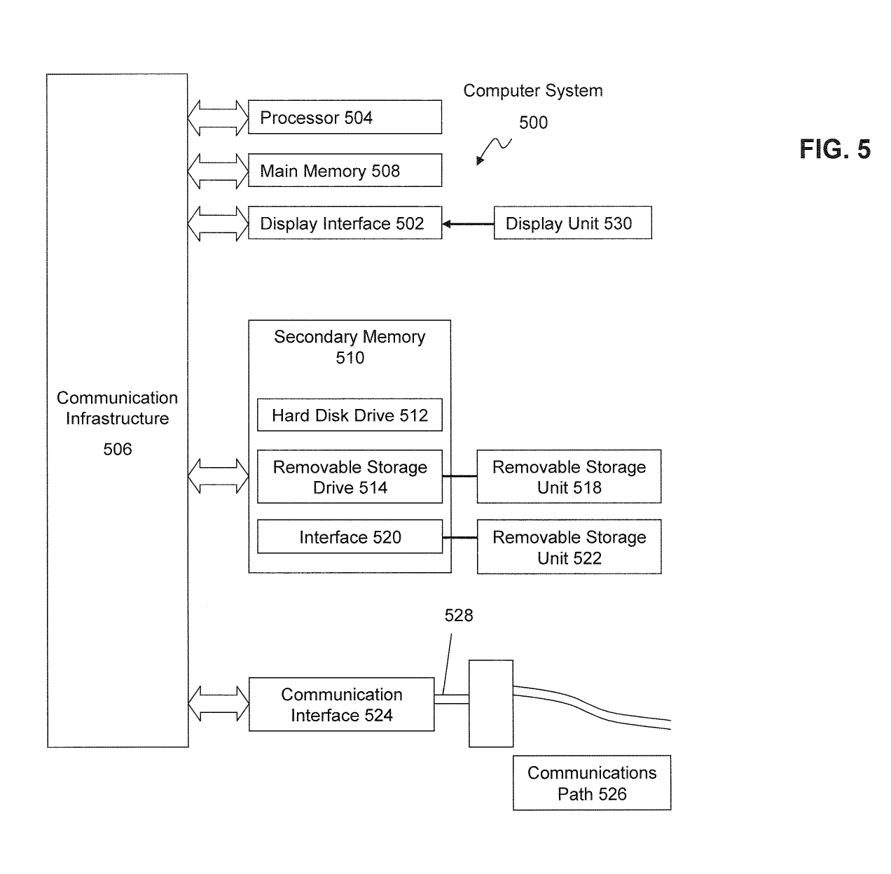

The present invention may be implemented using a combination of hardware, software and firmware in a computer system. In an aspect of the present invention, the invention is directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on a display unit 530. Computer system 400 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

Alternative aspects of the present invention may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 570, and signals 528. These computer program products provide software to the computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 410 to perform the features of the present invention. Accordingly, such computer programs represent controllers of the computer system 500.

In an aspect of the present invention where the invention is implemented using software, the software may be stored in a computer program product and loaded into computer system 500 using removable storage drive 514, hard drive 512, or communications interface 520. The control logic (software), when executed by the processor 504, causes the processor 504 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

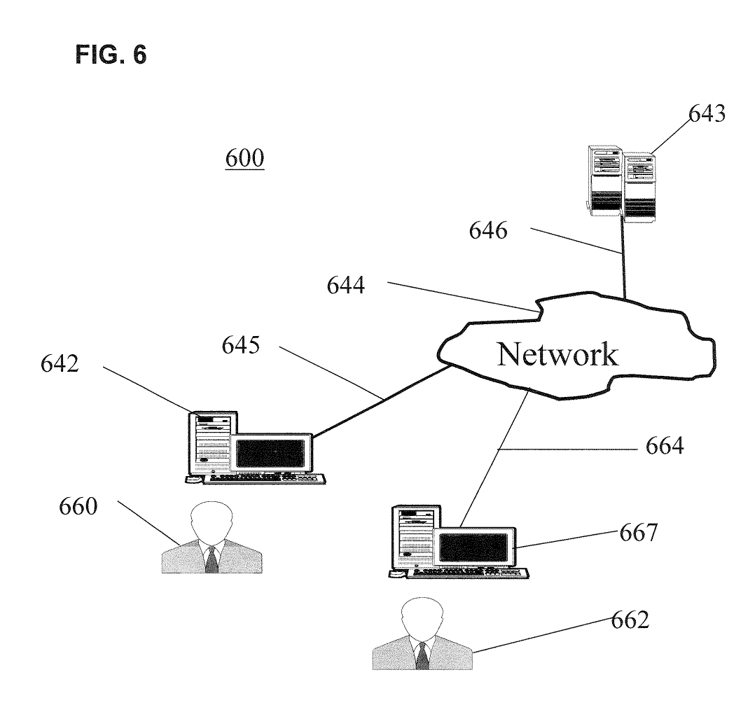

FIG. 6 shows a communication system 600 usable in accordance with aspects of the present invention. The communication system 600 includes one or more accessors 660, 662 (also referred to interchangeably herein as one or more “users”) and one or more terminals 642, 667. In one aspect, data for use in accordance with aspects of the present invention is, for example, input and/or accessed by accessors 660, 662 via terminals 642, 667, such as personal computers (PCs), minicomputers, mainframe computers, microcomputers, telephonic devices, or wireless devices, such as personal digital assistants (“PDAs”) or a hand-held wireless devices coupled to a server 643, such as a PC, minicomputer, mainframe computer, microcomputer, or other device having a processor and a repository for data and/or connection to a repository for data, via, for example, a network 644, such as the Internet or an intranet, and couplings 645, 646, 664. The couplings 645, 646, 664 include, for example, wired, wireless, or fiberoptic links. In another aspect, the method and system of the present invention operate in a stand-alone environment, such as on a single terminal.

While the foregoing disclosure discusses illustrative aspects and/or embodiments, it should be noted that various changes and modifications could be made herein without departing from the scope of the described aspects and/or embodiments as defined by the appended claims. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of generating a model for predicting loan behavior, the method comprising:
receiving loan data for a plurality of loans;
preparing the loan data for analysis;
grouping the loans into a plurality of hierarchical segments based on shared characteristics;
generating a logistic regression model for each segment; and
generating an overall prediction model for at least one of prepayment, delinquency, and default across the plurality of segments.

2. The method of claim 1, wherein preparing the loan data for analysis includes at least one of formatting, imputing missing data, and applying an outlier treatment to the loan data.

3. The method of claim 2, wherein imputing missing data includes resetting interest rates applicable to ARM products.

4. The method of claim 2, wherein applying an outlier treatment includes limiting the values of a particular field to a certain range.

5. The method of claim 1, wherein grouping the loans into a plurality of segments based on shared characteristics includes grouping the loans based on loan type.

6. The method of claim 5, wherein grouping the loans into a plurality of segments based on shared characteristics further includes grouping the loans based on change in Housing Price Index (HPI) since origination.

7. The method of claim 6, wherein grouping the loans into a plurality of segments based on shared characteristics further includes grouping the loans based on loan age.

8. The method of claim 7, wherein generating a logistic regression model for each segment includes generating a regression model for the probabilities of at least one of prepayment, default, and delinquency for each of the segments.

9. The method of claim 8, wherein generating a logistic regression model for each segment includes generating a regression model for the probabilities of each of prepayment, default, and delinquency for each of the segments.

10. The method of claim 9, further comprising:
generating a calendar month wise model by applying the corresponding model to generate probabilities for each segment for the calendar month and combining the generated probabilities.

11. The method of claim 9, further comprising:
scoring each loan at each age for probability or prepayment, default, and delinquency based on the corresponding generated models and the relevant data for each loan.

12. The method of claim 9, further comprising:
calculating the current amount outstanding at the end of each month based on the generated probability models.

13. The method of claim 12, further comprising:
calculating a probability of prepayment from the prepayment model; and
calculating a projected unpaid principle balance at each age of the loan by multiplying the probability of prepayment by the current unpaid balance.

14. A system for generating a model for predicting loan behavior, the system comprising:
means for receiving loan data for a plurality of loans;
means for preparing the loan data for analysis;
means for grouping the loans into a plurality of hierarchical segments based on shared characteristics;
means for generating a logistic regression model for each segment; and
means for generating an overall prediction model for at least one of prepayment, delinquency, and default across the plurality of segments.

15. The system of claim 14, wherein grouping the loans into a plurality of segments based on shared characteristics includes grouping the loans based on loan type, change in Housing Price Index (HPI) since origination, and loan age.

16. The system of claim 15, wherein generating a logistic regression model for each segment includes generating a regression model for the probabilities of each of prepayment, default, and delinquency for each of the segments.

17. A system for generating a model for predicting loan behavior, the system comprising:
a processor;
a user interface functioning via the processor; and
a repository accessible by the processor; wherein
the repository is configured to receive and store loan data for a plurality of loans, and wherein the processor is configured to:
prepare the loan data for analysis;
group the loans into a plurality of hierarchical segments based on shared characteristics;
generate a logistic regression model for each segment; and
generate an overall prediction model for at least one of prepayment, delinquency, and default across the plurality of segments.

18. The system of claim 17, wherein grouping the loans into a plurality of segments based on shared characteristics includes grouping the loans based on loan type, change in Housing Price Index (HPI) since origination, and loan age.

19. The system of claim 18, wherein generating a logistic regression model for each segment includes generating a regression model for the probabilities of each of prepayment, default, and delinquency for each of the segments.

20. A computer program product comprising a non-transitory computer usable medium having control logic stored therein for causing a computer to exchange user-generated community information, the control logic comprising:
first computer readable program code means for receiving loan data for a plurality of loans;
second computer readable program code means for preparing the loan data for analysis;
third computer readable program code means for grouping the loans into a plurality of hierarchical segments based on shared characteristics;
fourth computer readable program code means for generating a logistic regression model for each segment; and
fifth computer readable program code means for generating an overall prediction model for at least one of prepayment, delinquency, and default across the plurality of segments.

21. The computer program product of claim 20, wherein grouping the loans into a plurality of segments based on shared characteristics includes grouping the loans based on loan type, change in Housing Price Index (HPI) since origination, and loan age.

22. The computer program product of claim 21, wherein generating a logistic regression model for each segment includes generating a regression model for the probabilities of each of prepayment, default, and delinquency for each of the segments.
